(19) United States
(12) Patent Application Publication
(10) Pub. No.: US 2007/0078757 A1
(43) Pub. Date: Apr. 5, 2007

(54) Method and device for determining the credit of users of the optical disc

(76) Inventors: Bei Wang, Shanghai (CN); Declan Patrick Kelly, Eindhoven (NL); Yang Peng, Shangai (CN); Dahua He, Shanghai (CN)

Correspondence Address: PHILIPS INTELLECTUAL PROPERTY & STANDARDS, P.O. BOX 3001, BRIARCLIFF MANOR, NY, 10510, US

(21) Appl. No.: 10/580,498

(22) PCT Filed: Nov. 4, 2004
(86) PCT No.: PCT/IB04/52292

§ 371 Date: May 23, 2006

(30) Foreign Application Priority Data
Nov. 28, 2003 (CN) 200310119993.6

(51) Int. Cl. G06Q 40/00

(52) U.S. Cl. 705/38

(57) ABSTRACT

The present invention relates to the credit of users, in particular to the determination of the credit of users of the optical disc.

### BACKGROUND ART

The development of network technology not only brings about many network products such as network optical disc, but also provides many network technology solutions for problems, such as determining the credit of users through network.

In many commercial activities, keeping constant users is more important than developing new users. The standard of determining whether a user is a constant user or not is usually the intimacy of the business relationship between said user and the dealer, while the intimacy of the business relationship could be indicated by the credit of the user, that is, the closer the business relationship is, the higher the credit of the user and vice versa.

Network optical disc or other network storage medium could store conventional programs (hereinafter referred to as main contents), some auxiliary contents (hereinafter referred to as auxiliary contents) as well as some network link information, etc. The network link information stored on the optical disc makes the optical disc not only a gigantic information bank, but also a window for acquiring more information, which is one of the reasons why network optical disc is more preferred by users.

FIG. 1 is a schematic diagram of the link between the network disc and network server. The user inserts optical disc 110 to network optical disc player 120 which reads the link information on optical disc 110 and exchanges the link information with the network server 140 via Internet 130. The link information includes the player ID of player 120, etc. By analyzing the link information, the network server 140 confirms the user of the optical disc and makes a link record for the user, such as accumulating the times of links and so on.

As far as the main contents on the optical disc are concerned, the user has already paid the corresponding fees when obtaining the optical disc, so they should be used without limitation. However, this is not the case with the auxiliary contents and network link information on the optical disc. The optical disc service provider (e.g., the optical disc seller and optical disc renter, etc.) could set corresponding using conditions. For example, only when a user satisfies the credit requirement or has enough accumulated marks could the user use such contents; otherwise, the user will not be able to use them.

The commonly set using conditions by the optical disc service provider is the credit of a user, i.e., the accumulated times that the user links to the network server or the equivalent corresponding accumulated marks, etc. The more the accumulated times are, the higher the credit is. If the credit of a user meets the requirements of the optical disc service provider, the user could obtain more and richer contents. For instance, if a user links to a specified network server more than 30 times a month, the user will be able to browse the background information of a main content and the like on a certain website. Otherwise, the optical disc service provider may not provide any other contents except for the main contents.

However, the problem existing with the above-mentioned determining method is that if the same optical disc links to the network server for many times, the user may also have a very high credit and thus enjoy more favorable services. This method will not encourage the user to buy or rent more optical discs and thus is commercially meaningless for the optical disc service provider.

Therefore, there is the need to provide an improved method and device for determining the credit of users of the optical disc, which enables the optical disc service provider to recognize users of the optical disc that are commercially significant.

Contents of the Invention

The present invention provides a method and a device for determining the credit of users of the optical disc, which could overcome the problems in the prior art.

The method for determining the credit of users of the optical disc provided by the present invention comprises the steps of making statistics of the information of the first registration of the optical disc by a user so as to produce a statistical result, comparing the statistical result with a preset value and determining the credit of the user according to the result by comparison.

The device for determining the credit of users of the optical disc provided by the present invention comprises a statistics device for making statistics of the information of the first registration by a user of the optical disc to produce a statistical result, a comparing device for comparing said statistical result with a preset value to produce a result by comparison and a determining device for determining the credit status of said user on the basis of said result by comparison.

The method and device for determining the credit of users as provided by the present invention could encourage the optical disc consumption of the users and bring economic benefits to the optical disc service provider.

Other objects and attainments together will be a full understanding of the invention will become apparent and appreciated by referring to the following description and claims taken in conjunction with the accompanying drawings.

### DESCRIPTION OF FIGURES

The present invention is explained in more details in conjunction with the embodiments with reference to the figures.

FIG. 1 is the schematic diagram of the link of the network optical disc to the network server;

FIG. 2 is the schematic diagram of the embodiments of some databases in the network server according to present invention;

FIG. 3 is the block diagram of the embodiment of the device for determining the credit of users according to present invention; and

FIG. 4 is the flow chart of the embodiment of the method for determining the credit of a user according to the present invention.

Throughout the drawings, the same reference numerals indicate the same, similar or corresponding features or functions.

Specific Embodiments

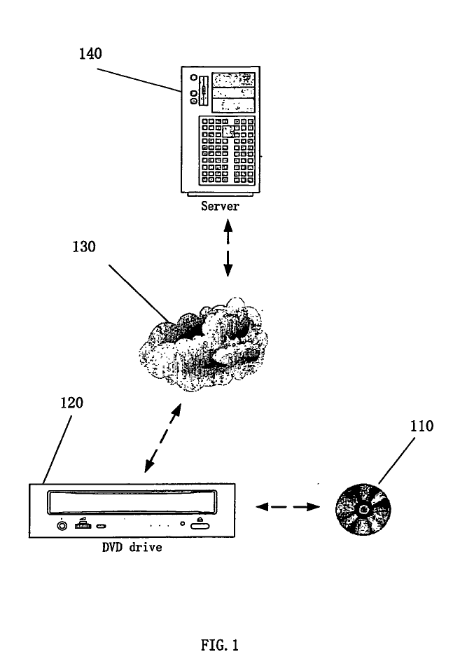

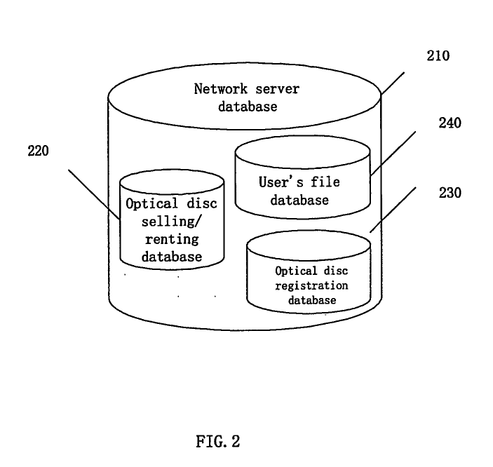

FIG. 2 is the schematic diagram of the embodiments of some databases in the network server according to present invention. The database 210 of the network server (140 as in FIG. 1) includes an optical disc selling/renting database 220, optical disc registration database 230, and users' file database 240 for recording the credit status of users and other information of users.

Database 220 records the selling or renting information of each optical disc, including the ID of the optical disc, the time and amount of money of selling or renting, etc. After the optical disc service provider provides an optical disc, the information in the database 210 will be updated timely.

The database 230 records the information that each of the optical discs provided by the optical disc service provider registered on the specified network server, including the first registration time and registration manner (e.g., by the optical disc player or the user's password etc.) after the optical disc is sold or rented every time, the accumulated information of the first registered optical disc, etc., and also the information of registrations of the optical disc other than the first registration. Said database will be updated timely according to the link situation of the optical disc to the network server each time. The databases 220 and 230 provide data information for determining the credit of users.

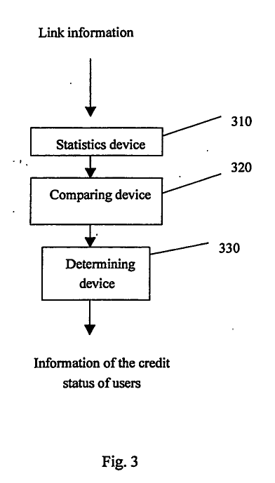

FIG. 3 is the block diagram of the embodiment of the device 300 for determining the credit of users used in the network server 140 according to the present invention. Device 300 comprises a statistics device 310 for making statistics of the information of the first registration of the optical disc by a user, such as the amount of first registered optical discs or the amount of money of the optical discs used for the first registration, or the times of the links to the network, etc.

Device 300 further comprises a comparing device 320 in which, there is a preset value for comparing with the statistical result of the statistics device 310 and which determines whether the credit of said user has reached said preset value or not.

Device 300 further comprises a determining device 330 for updating the user credit according to the comparison result of device 320. If the credit of a user has reached the corresponding preset value, the determining device 330 updates the credit record of the user to a new credit of the user; and if the credit of the user has not yet reached the corresponding preset value, maintains the current credit of the user.

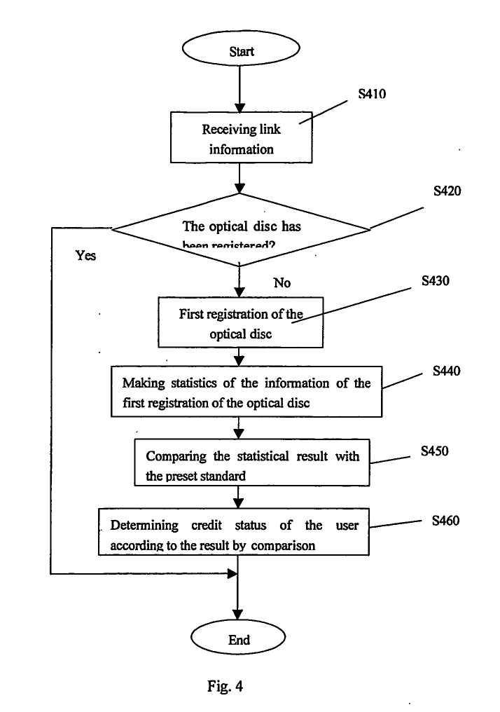

FIG. 4 is the flow chart of the embodiment of a method for determining the credit of a user for use in a network server according to the present invention. Firstly, the network server receives the link information of the network optical disc player (step 410). The link information includes the disc ID, or it could also include the information such as player ID, user ID, “cookies” technology.

On the basis of the link information and the record in the database (database 220 and 230 as shown in FIG. 2)of the network server, the network server determines whether said optical disc has registration record in the network server (step S420) or not. If the database has the registration record information of said optical disc which has been sold or rent currently, then it is indicated that said optical disc is not registered for the first time and said link will not affect the credit determination of the user of the optical disc.

If there is no registration record of said optical disc in the record of the database of the network server, the network server will perform the first registration for said optical disc (step S430). The network server will record the ID information, time, link manner and etc. of said optical disc which is first registered in the database thereof. The network server will make statistics of the information of the first registration of the optical disc by said user (step S440). And the statistical content may includes the amount of optical discs first registered by said user, the amount of money spent by said user for the optical discs and corresponding conversion value (such as the converted accumulated marks, etc.) of said user by first registering the optical disc information.

Compare the statistical result and the preset standard (step S450) so as to determine whether the credit of the user reaches the preset standard or not. The preset standard may include a preset value such as an amount of optical discs, an amount of money, accumulated marks or the like. That is, if the amount of optical discs is 100, the amount of money is 1000, the accumulated marks reaches 10000 or the like, then said user is a user of credit. It may also include a level sequence comprising many values. For example, when the amount of the optical discs reaches 20 or the amount of money reaches 200RMB, the user is a user of the first level credit, and when the amount of optical discs reaches 40 or the amount of money reaches 400RMB, the user is a user of the second level credit, and so on. The preset value could also be a higher or lower value of the amount or the total amount of money of the first registered optical discs, etc., and it could be specifically determined by the optical disc service provider according to their needs.

The network server determines the credit status of the user according to the comparison result (step S460). If a user meets the corresponding preset standard, the user's credit will be updated; if the preset standard is a level standard, the credit level of the user will be determined.

After determining the credit of the user, the optical disc service provider could provide service contents or service mode of different favorable degrees according to the credit of the user.

The method and device provided by the present invention are not limited to network optical disc, and if the optical disc ID could be provided to the network server, they could also be applied to non-network optical disc. However, the network optical disc could reflect the advantages of the present invention better because there are more contents on network optical disc for the optical disc service provider to control, and thus it is convenient for providing different content and service according to different credit of users.

While the invention has been described in conjunction with specific embodiments, it is evident that many alternatives, modifications and variations will be apparent to those skilled in the art in light of the foregoing description. Accordingly, it is intended to embrace all such alternatives, modifications and variations as fall within the spirit and scope of the appended claims of the present invention.

What is claimed is:

1. A method for determining the credit of a user of the optical disc comprising the following steps:
(a) making statistics of the information of the first registration of the optical disc by a user to produce a statistical result;
(b) comparing the statistical result with a preset value; and
(c) determining the credit of the user according to the result by comparison.

2. The method according to claim 1, wherein the information of the first registration of the optical disc by a user comprising:
an amount of optical discs first registered by the user.

3. The method according to claim 1, wherein the information of the first registration of the optical disc by an user comprising:
an amount of money spent by the user on the first registration of the optical disc.

4. The method according to claim 3, wherein said amount of money is that spent on buying the optical discs.

5. The method according to claim 3, wherein said amount of money is that spent on renting the optical discs.

6. The method according to claim 1, wherein the information of the first registration of the optical disc by an user comprising:
a conversion value that concerns the credit of the user.

7. The method according to claim 1, wherein said preset value comprising at least one of the following:
an amount of optical discs, an amount of money, and a conversion value.

8. A device for determining the credit of a user of the optical disc, comprising:
a statistics device for making statistics of the information of the first registration of the optical disc by a user to produce a statistical result;
a comparing device for comparing the statistical result with a preset value to produce a result by comparison; and
a determining device for determining the credit of the user according to the result by comparison.

9. A server, comprising:
a link device for receiving the information sent by a user terminal; and
a determining device for determining the credit of a user, comprising,
a statistics device for making statistics of the information of the first registration of the optical disc by a user base on the information of the first registration by a user contained in the received information to produce a statistical result;
a comparing device for comparing the statistical result with a preset value to produce a result by comparison, and
a determining device for determining the credit of the user according to the result by comparison.

10. A server according to claim 9, further comprising:
a storage device for recording the information of the credit of users.

11. A server according to. claim 9, further comprising:
a storage device for recording the information of the sales of optical discs.

12. A server according to claim 9, further comprising:
a storage device for recording the information of the rents of optical discs.
